(19) United States
(12) Patent Application Publication
(10) Pub. No.: US 2017/0262922 A1
(43) Pub. Date: Sep. 14, 2017

(54) Rule-Based Reporting Workflow

(71) Applicants: Vipin Namboodiri, Karnataka (IN); Boppana Visweswara Rao, Karnataka (IN)

(72) Inventors: Vipin Namboodiri, Karnataka (IN); Boppana Visweswara Rao, Karnataka (IN)

(73) Assignee: Ricoh Co., Ltd., Tokyo (JP)

(21) Appl. No.: 15/067,083

(22) Filed: Mar. 10, 2016

(51) Int. Cl. G06Q 30/06

(52) U.S. Cl. CPC G06Q 30/0631

(57) ABSTRACT

The disclosure includes a system and method for determining and notifying a service provider to receive a consultation request based on dynamically generated rules. A scheduling and reporting application receives information about a plurality of service providers, receives a consultation request automatically generated based on a report associated with a customer, determines attributes of the consultation request, generates a set of rules based on the attributes of the consultation request, identifies, from the plurality of service providers, a recommended list of service providers by evaluating the information about the plurality of service providers based on the set of rules, and forwards the consultation request generated based on the report associated with the customer to the service providers of the recommended list.

### BACKGROUND

1. Field of the Invention

The specification generally relates to scheduling a consultation based on a consultation request. In particular, the specification relates to a system and method for determining and notifying a service provider of a consultation request based on dynamically generated rules.

2. Description of the Background Art

Telemedicine provides healthcare solutions for patients that are geographically separated from care-givers. As the usage of telemedicine systems grows rapidly, telemedicine systems face some challenges. One of the challenges is to solve scheduling problems. Simply providing a patient with a remote doctor fails to solve the problem of automatically matching the patient with an appropriate doctor in real time. Also, the information about the patient and the doctor used for scheduling a consultation may change over time. Therefore scheduling of the consultation needs to be adapted to such changes. Sometimes the consultation is based on a report associated with a patient. In such cases, a quick response from an appropriate doctor is needed.

### SUMMARY

The techniques introduced herein overcome the deficiencies and limitations of the prior art, at least in part, with a system and method for determining and notifying a service provider of a consultation request based on dynamically generated rules. The system is configured to receive information about a plurality of service providers and receive a consultation request automatically generated based on a report associated with a customer. The system is further configured to determine attributes of the consultation request. The system is further configured to generate a set of rules based on the attributes associated with the consultation request. The system is further configured to identify, from the plurality of service providers, a recommended list of service providers by evaluating the information about the plurality of service providers based on the set of rules. The system is further configured to forward the consultation request generated based on the report associated with the customer to a service provider from the recommended list.

Other aspects include corresponding methods, systems, apparatuses, and computer program products for these and other innovative aspects.

The features and advantages described herein are not all-inclusive and many additional features and advantages will be apparent to one of ordinary skill in the art in view of the figures and description. Moreover, it should be noted that the language used in the specification has been principally selected for readability and instructional purposes and not to limit the scope of the techniques described.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 depicts a high-level block diagram illustrating one embodiment of a system for determining and notifying a service provider of a consultation request based on dynamically generated rules.

FIG. 2 depicts a block diagram illustrating one embodiment of a computing device including a scheduling and reporting application.

FIG. 3 depicts a flow diagram illustrating one embodiment of a method for determining and notifying a service provider of a consultation request based on dynamically generated rules.

FIG. 4 depicts a flow diagram illustrating one embodiment of a method for receiving a consultation request from a customer, and determining and notifying a service provider of a consultation request using a dynamic rule-based mechanism.

FIG. 5 depicts a flow diagram illustrating one embodiment of a method for generating a consultation request based on a report associated with a customer and determining to which service provider the consultation request should be routed to using a dynamic rule-based mechanism.

### DETAILED DESCRIPTION

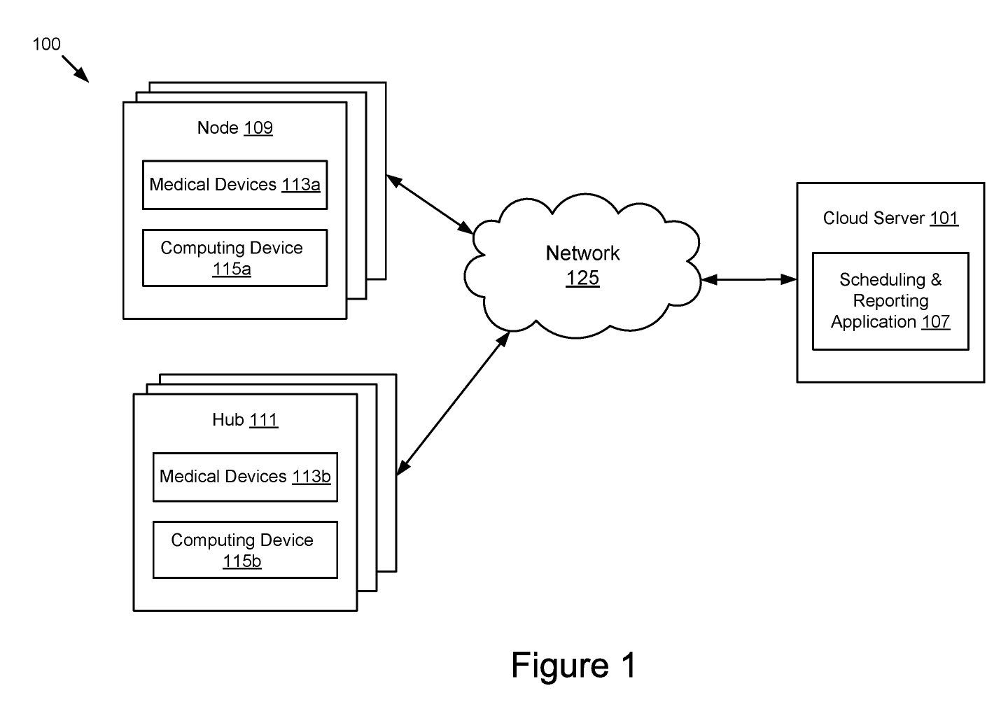

FIG. 1 depicts a high-level block diagram illustrating one embodiment of a system 100 for determining and notifying a service provider of a consultation request based on dynamically generated rules. The illustrated system 100 may be a cloud based telemedicine system. The illustrated system 100 includes one or more nodes 109, a cloud server 101, and one or more hubs 111. In the illustrated embodiment, the entities of the system 100 are communicatively coupled via a network 125.

Although FIG. 1 depicts and the corresponding text describes scheduling services in a cloud based telemedicine system 100, it is to be understood that the components illustrated and the techniques described herein are also applied to scheduling services in other systems and configurations. For example, in different embodiments, a customer can be a bank customer, an internet user, a client, etc. A service provider can be a banker, an internet provider, a lawyer, etc. The techniques described herein can be utilized to schedule services from various service providers for various customers based on consultation requests in various formats. In the following description, medical service related terms such as “patient(s),” “doctor(s),” and “physician(s)” may be used to adapt to the telemedicine system 100 depicted in FIG. 1. The generalized terms “customer(s)” and “service provider(s)” may also be used in the description of different embodiments.

The network 125 can be a conventional type, wired or wireless, and may have numerous different configurations including a star configuration, token ring configuration or other configurations. Furthermore, the network 125 may include a local area network (LAN), a wide area network (WAN) (e.g., the Internet), and/or other interconnected data paths across which multiple devices may communicate. In some embodiments, the network 125 may be a peer-to-peer network. The network 125 may also be coupled to or include portions of a telecommunications network for sending data in a variety of different communication protocols. In some embodiments, the network 125 may include Bluetooth communication networks or a cellular communications network for sending and receiving data including via short messaging service (SMS), multimedia messaging service (MMS), hypertext transfer protocol (HTTP), direct data connection, WAP, email, etc. Although FIG. 1 illustrates one network 125 coupled to the cloud server 101, the nodes 109, and the hubs 111, in practice one or more networks 125 can be connected to these entities.

A node 109 is a place where a patient interacts with the system 100, for example, registers with the system, schedules a consultation request, receives a medical consultation, etc. In some embodiments, the node 109 is located remotely from a hub 111. For example, the node 109 may be a facility physically located in a rural area while a hub 111 may be physically located in a city. In another example, the node 109 may be a patient's home and the hub 111 may be a nearby or distant hospital. In other embodiments, the node 109 may be mobile, for example, a vehicle.

The node 109 is staffed by personnel (e.g., medical assistants) that are trained to assist a patient during a medical visit. In some embodiments, the node 109 includes a computing device 115a and medical devices 113. The medical assistants (e.g., a registered nurse, a lab technician) at the node 109 operate the computing device 115a and medical devices 113. For example, a medical assistant is trained to use the medical devices 113 to obtain the patient's medical information and to use the computing device 115a to register the patient for medical consultation and/or communication with the hub 111 or hub personnel.

In some embodiments, the computing device 115a can be a laptop computer, a desktop computer, a tablet computer, a mobile telephone, a personal digital assistant (PDA), a mobile email device, a television with one or more processors embedded therein or coupled thereto or any other electronic device capable of accessing the network 125. A patient may use the computing device 115a to send out a consultation request to the cloud server 101 and to obtain medical consultation from a doctor at the hub 111, etc. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number.

In some embodiments, the medical devices 113 but are not limited to, a stethoscope, a blood pressure meter, a pulse oximeter, a thermometer, an ophthalmoscope, a weight and height scale, an otoscope, a camera, a telecardiology device (e.g. an ECG machine), a telepathology device (e.g. a microscope), a teledermatology device (e.g. a high-resolution camera), a teleradiology device (e.g. an ultrasound machine), etc. The medical device 113 works with the computing device 115a to allow node personnel to communicate with other entities of the system 100. For example, the computing device 115a receives a report associated with a patient including a medical test result from the medical device 113, and sends the report to the cloud server 101 to generate a consultation request for the patient. The direct communication between the computing device 115a and the medical device 113 without manual intervention beneficially reduces errors from node personnel misreading the medical device 113 and transcription errors from node personnel miss-recording the test result of the medical device 113.

A hub 111 is a place where a healthcare provider (e.g., a doctor) interacts with the system 100. In one embodiment, a hub 111 may be a centralized physical facility that connects with the nodes 109 and allows a healthcare provider to remotely consult with and diagnose the patient at the node 109 on an as needed basis using a computing device 115b. In some embodiments, the hub 111 may include medical devices 113b similar to those described above with reference to node 109.

The hub 111 includes at least one computing device 115b, which is used by the healthcare provider to communicate with the cloud server 101 and the node 109. The computing device 115b is similar to the computing device 115a described above and the description will not be repeated here. A healthcare provider at the hub 111 uses the computing device 115b to register the system, log into the system, search for patients, schedule patients, order prescriptions, make notes, perform video conferencing, generate reports, perform analytics, etc. By allowing remote consultation of a patient at a node 109 by a healthcare provider at a hub 111 in the telemedicine system 100, the healthcare provider is effectively used and patients may receive high quality medical care.

A cloud server 101 may be either a hardware server, a software server, or a combination of software and hardware. The cloud server 101 may be, or may be implemented by, a computing device including a processor, a memory, applications, a database, and network communication capabilities. In some embodiments, the cloud server 101 communicates with the node 109 and the hub 111 to receive information about a plurality of service providers and a customer, determine to which service providers a consultation request of the customer should be routed based on the received information, and contact at least one service provider to handle the consultation request.

In some embodiments, the cloud server 101 is an electronic medical record (EMR) server. The cloud server 101 includes EMR storage (not shown). In some embodiments, the EMR storage is a database that includes electronic medical records for patients of the telemedicine system 100. Each time the node 109 or hub 111 transmits information about a patient, the EMR storage updates the electronic medical record of the patient.

In some embodiments, the cloud server 101 includes a scheduling and reporting application 107. The scheduling and reporting application 107 may include software and/or logic to provide the functionality for determining a service provider to which a consultation request should be routed based on dynamically generated rules and notifying the service provider. In some embodiments, the scheduling and reporting application 107 can be implemented using programmable or specialized hardware. In some embodiments, the scheduling and reporting application 107 can be implemented using a combination of hardware and software. In other embodiments, the scheduling and reporting application 107 may be stored and executed on a combination of the node 109, the hub 111, and the cloud server 101.

In some embodiments, the scheduling and reporting application 107 receives information about a plurality of service providers. For example, the scheduling and reporting application 107 receives a specialty, a name, a gender, and a location of a doctor. The scheduling and reporting application 107 receives, from a customer (e.g., a walk-in patient), a consultation request and attributes associated with the consultation request. The attributes indicate preferences of the customer for a service provider that may handle the consultation request of the customer, such as a geographical distance from the customer, time of day, language spoken, specialty, etc. In some embodiments, the scheduling and reporting application 107 provides a pre-filtered attribute list to the customer as options of the attributes that the customer can select. The attributes list is pre-filtered based on the information about the plurality of service providers. For example, the attribute list may not include a doctor if the doctor is on vacation, or may place the four doctors that have treated a patient in the past on top of the list shown to this patient.

The scheduling and reporting application 107 generates a set of rules based on the attributes associated with the consultation request, for example, a first rule that groups service providers based on linguistic ability and a second rule that limits the service providers within a 15 mile radius of a given location. The generation of the rules is dynamic. For example, the scheduling and reporting application 107 may edit a rule if it conflicts with another rule, may modify a rule based on a regulation change (e.g., a change of a clinic protocol), or may add a new rule in run-time based on a new customer preference.

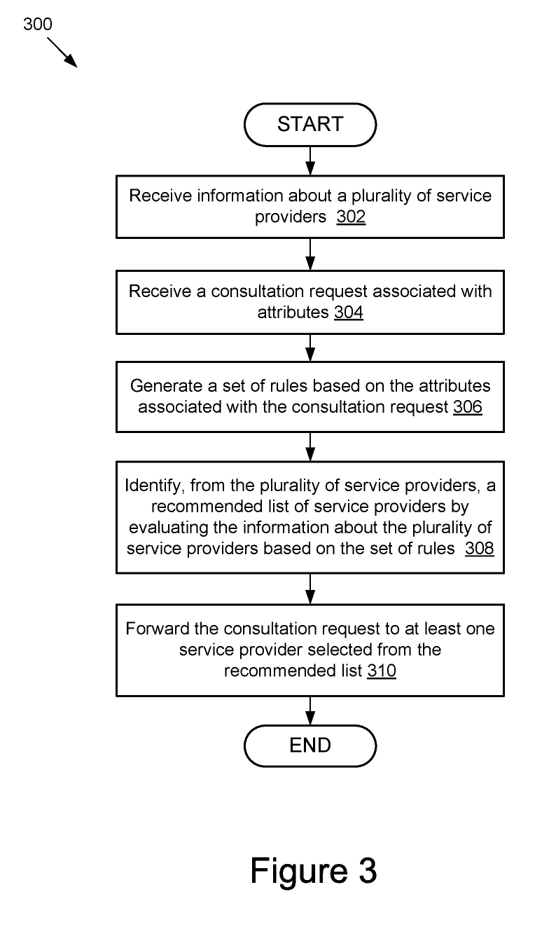

The scheduling and reporting application 107 evaluates the information about the plurality of service providers based on the set of rules to identify a recommended list of service providers that satisfy the set of rules. The scheduling and reporting application 107 provides the recommended list of service providers to the customer and instructs the customer to select a service provider from the recommended list. The scheduling and reporting application 107 then establishes a connection between the customer and the selected service provider responsive to receiving an acceptance of the consultation request from the selected service provider. In some embodiments, the customer may request the scheduling and reporting application 107 to identify and notify one or more service providers based on the set of rules and/or preferences associated with the request. In this scenario, the scheduling and reporting application 107 notifies one or more service providers that meet the criteria without sending the recommendation list back to the customer. When a consultation request is forwarded to more than one service provider based on the set of rules and/or preferences associated with the request, any notified service provider may accept the consultation. Upon receipt of acceptance of the consultation, the scheduling and reporting application 107 will inform all other service providers that the consultation has already been accepted and is no longer available. The operation of the scheduling and reporting application 107 and the functions listed above are described below in more detail with reference to FIGS. 3-5.

The techniques described herein are advantageous in various aspects. First, the scheduling and reporting system described herein is based on a dynamic rule-based mechanism. The system defines and modifies rules in run-time to adapt to the context of scheduling implementations and any possible changes, and therefore accurately determines a service provider to receive a consultation request based on the rules reflecting the context and changes. Second, the scheduling and reporting system described herein allows pre-filtering of customers by presenting pre-filtered attribute options to customers such that the pre-filtered customers have met certain criteria of service providers before scheduling consultations with any service providers. As a result, the acceptance rate of consultations among the service providers is increased. Third, the scheduling and reporting system described herein filters and establishes a connection between a customer and a matched service provider, and therefore reduces the network traffic that would otherwise be caused by connecting a customer to all available service providers. In addition, the system described herein determines that a service provider is available if the service provider logged into the system, and therefore reduces the network traffic that would otherwise be caused by a plurality of service providers indicating their availability.

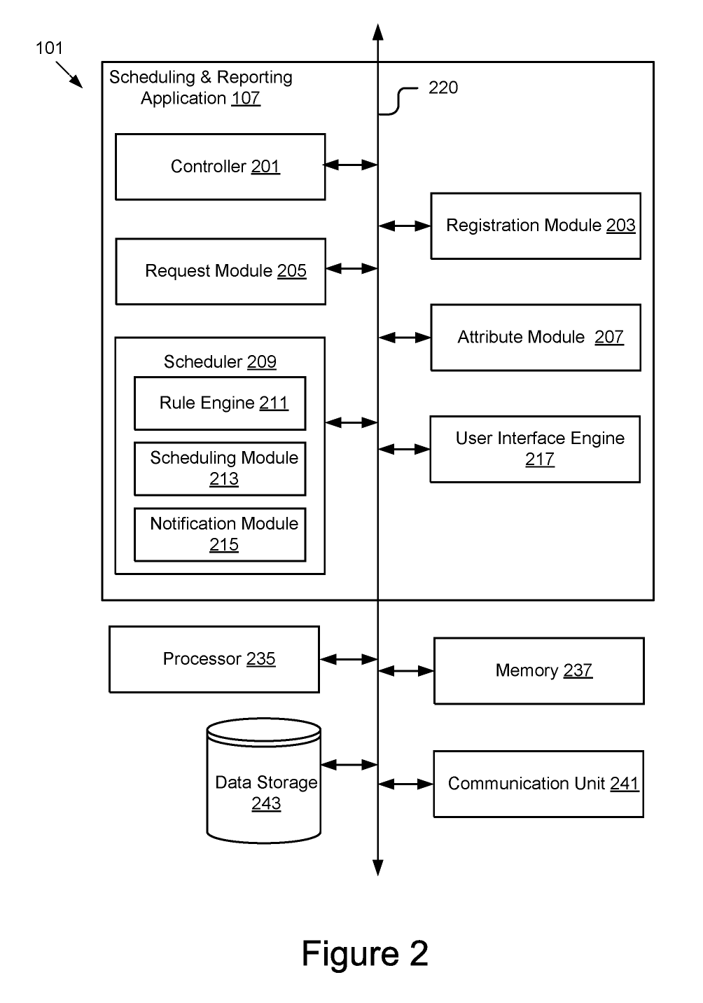

FIG. 2 depicts a block diagram illustrating one embodiment of a cloud server 101 including a scheduling and reporting application 107. The cloud server 101 may also include a processor 235, a memory 237, a communication unit 241, and data storage 243 according to some examples. The components of the cloud server 101 are communicatively coupled to a bus or software communication mechanism 220 for communication with each other.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. In some implementations, the processor 235 may be capable of generating and providing electronic display signals to a display device, supporting the display of user interfaces used in scheduling a consultation, and performing complex tasks including generating rules, identifying a recommended list of service providers, etc. In sonic implementations, the processor 35 may be coupled to the memory 237 via the bus 220 to access data and instructions therefrom and store data therein. The bus 220 may couple the processor 235 to the other components of the cloud server 101 including, for example, the memory 237, the communication unit 241, the scheduling and reporting application 107, and the data storage 243. It will be apparent to one skilled in the art that other processors, operating systems, and physical configurations are possible.

The memory 237 may store and provide access to data for the other components of the cloud server 101. In some implementations, the memo 37′ ay store instructions and/or data that may be executed by the processor 235. The instructions and/or data may include code for performing the techniques described herein. For example, in one embodiment, the memory 237 may store the scheduling and reporting application 107. The memory 237 is also capable of storing other instructions and data, including, for example, an operating system, hardware drivers, other software applications, databases, etc. The memory 237 may be coupled.

to the bus 220 for communication with the processor 235 and the other components of the cloud server 101,

The memory 237 may include one or more non-transitory computer-usable (e.g., readable, writeable) device, a dynamic random access memory (DRAM) device, a static random access memory (SRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The communication unit 241 is hardware for receiving and transmitting data by linking the processor 235 to the network 125 and other processing systems. The communication unit 241 receives data such as attributes of a user from the node 109 or the hub 111, and transmits the attributes to the controller 201. The communication unit 241 also transmits information to the node 109 or the hub 111 for display. For example, the communication unit 241 transmits a recommended list of service providers to the node 109 for a customer accessing the node 109 to select a service provider for providing a consultation to the customer. The communication unit 241 is coupled to the bus 220. In one embodiment, the communication unit 241 may include a port for direct physical connection to the network 125. In another embodiment, the communication unit 241 may include a wireless transceiver (not shown) for exchanging data with the client device 115 or any other communication channel using one or more wireless communication methods, such as IEEE 802.11, IEEE 802.16, Bluetooth®, cellular communications, or another suitable wireless communication method.

The data storage 243 is a non-transitory memory that stores data for providing the functionality described herein. In the illustrated embodiment, the data storage 243 is communicatively coupled to the bus 220. The data storage 243 stores information that is used to provide functionality as described herein. For example, the data storage 243 may store information of service providers, consultation requests for customers and associated attributes, reports of the customers, rules generated based on the attributes, recommended lists of service providers, selections of the service providers, notifications of acceptance of selected service providers, etc. The data stored in the data storage 243 is described below in more detail.

The components of the scheduling and reporting application 107 may include software and/or logic to provide the functionality they perform. In some embodiments, the components can be implemented using programmable or specialized hardware including a field-programmable gate array (FPGA) or an application-specific integrated circuit (ASIC). In some embodiments, the components can be implemented using a combination of hardware and software executable by processor 235. In some embodiments, the components are instructions executable by the processor 235. In some implementations, the components are stored in the memory 237 and are accessible and executable by the processor 235.

The controller 201 may include software and/or logic to control the operation of the other components of the scheduling and reporting application 107. The controller 201 controls the other components of the scheduling and reporting application 107 to perform the methods described below with reference to FIGS. 3-5. In other implementations, the processor 235, the memory 237 and other components of the scheduling and reporting application 107 can cooperate and communicate without the controller 201.

In some embodiments, the controller 201 sends and receives data, via the communication unit 241, to and from one or more of the node 109 and the hub 111. For example, the controller 201 receives data for providing a graphical user interface to a user, and causes the user interface engine 217 to generate the user interface for display to the user on the computing device 115a of the node 109.

In some embodiments, the controller 201 receives data from other components of the scheduling and reporting application 107 and stores the data in the data storage 243. For example, the controller 201 may receive customer attributes and information about a plurality of service providers from the attribute module 207 and store the attributes and information in the data storage 243. In other embodiments, the controller 201 retrieves data from the data storage 243 and sends the data to other components of the scheduling and reporting application 107. For example, the controller 201 may retrieve previous reports associated with a customer from the data storage 243, and transmit the reports to the scheduler 209 for determining where to route a consultation request generated based on a report associated with the customer.

The registration module 203 may include software and/or logic to provide the functionality for registering a user. The user can be a service provider or a customer. In the illustrated embodiment of FIG. 1, a service provider is a healthcare provider and a customer is a patient. In other embodiments, a service provider can be a cable provider, a lawyer, etc., while the customer to whom the service provider provides consultations can be a cable user, a client, etc.

The registration module 203 registers a user such that the user can be scheduled to provide or obtain a consultation. In some embodiments, a registered service provider can be scheduled to provide a virtual and remote consultation to a customer without a prior appointment. For example, a walk-in patient can be scheduled to receive a virtual medical consultation from a tele-physician. In other embodiments, a registered service provider can be scheduled to provide offline consultation for reporting. For example, once an electrocardiogram (ECG) for a patient has been taken, a registered doctor may be scheduled and notified to process the ECG of the patient. In some other embodiments, an appointment is scheduled between a registered service provider and a customer. Similarly, a registered service provider can be scheduled based on open access scheduling to provide a consultation to a customer. For example, if a scheduled time of a doctor has been cancelled, this time can be rescheduled for the doctor to provide a consultation to a walk-in patient.

In some embodiments, the registration module 203 may receive information about a user (e.g., a service provider or a customer), and register the user based on the information. For a plurality of registered service providers, one of the service providers may be scheduled to provide a consultation to a customer based on information provided by the plurality of registered service providers and attributes associated with a consultation request of the customer. In some embodiments, the registration module 203 registers a plurality of service providers and assigns registration identifiers to the plurality of service providers. A registered service provider associated with a registration identifier can log into the cloud server 101 to participate in the scheduling of consultation requests. The login information associated with the service provider (e.g., login credentials) signals other components of the scheduling and reporting application 107 that the service provider is available and a consultation request of a customer can be routed to this service provider. In some embodiments, both service providers and customers register to participate in the scheduling of consultation requests. In other embodiments, to participate in the scheduling of consultation requests, the registration of service providers and customers is optional.

The request module 205 may include software and/or logic to provide the functionality for receiving a consultation request. The consultation request is used to request a consultation from a service provider for a customer. For example, the request module 205 receives a consultation request for a virtual and remote medical consultation of a patient. In some embodiments, the consultation request is in the form of structured JavaScript object notation (JSON) request. One skilled in the art will recognize that other forms of consultation requests are possible.

In other embodiments, the request module 205 receives a report associated with a customer and generates a consultation request based on the report. The consultation request may include a type of consultation and the report associated with the customer. The report associated with the customer may be a medical report such as an x-ray, an electrocardiogram (ECG), a mammogram, or the like, a financial report such as a credit card application, a tax report, etc. The report associated with the customer may be generated on the node 109 or the hub 111. The report associated with the customer triggers a consultation for the customer, which causes a consultation request for the consultation to be generated by the request module 205 on the cloud server 101. For example, the computing device 115a at the node 109 captures an x-ray taken for a patient by the medical device 113 and transmits the x-ray to the request module 205 via the communication unit 241 of the cloud server 101. The request module 205 generates a consultation request based on the x-ray such that the x-ray can be timely analyzed by a doctor. It is advantageous that the request module 205 automatically generates a consultation request for a customer based on a report associated with the customer without waiting for the consultation request to be manually inputted by the customer or an attendant at the node 109.

The attribute module 207 may include software and/or logic to provide the functionality for receiving and processing information about a plurality of service providers, and determining attributes associated with a consultation request of a customer. The attribute module 207 transmits the information, the consultation request, and the attributes to the scheduler 209 for scheduling a consultation for the customer.

In some embodiments, the attribute module 207 receives and processes information about a service provider provided by the service provider when logging into the system 100. The information may describe abilities of a service provider, for example, linguistic ability (e.g., what languages the service provide can speak), a specialty (e.g., major in immunology or cancer), licenses, practice, provider organizations, etc. Other information provided by the service provider may include a name, a gender, a registration identifier, work locations, work hours, etc.

In some embodiments, the attribute module 207 also determines that the service provider has logged into the system, and updates the information about the service provider with a status indicating the availability of the service provider. Once a service provider has logged in, the attribute module 207 determines that the service provider is available, updates the availability status, and therefore relieves the service provider from manually entering the availability status.

In some embodiments, the attribute module 207 further groups a service provider and updates the information about the service provider with one or more groups that is assigned to the service provider. The attribute module 207 may group a service provider based on a location, a specialty, linguistic ability, practice, provider organizations, etc. A service provider can be a member of multiple groups. For example, the attribute module 207 determines that a doctor is part of a cardiologist group, an English-speaking group, and a Chinese-speaking group, and adds the three groups to the information about the doctor. The attribute module 207 may dynamically define or modify the groups of a service provider at run time in the context of scheduling implementation. For example, responsive to a consultation request for an ECG, the attribute module 207 may initially classify a doctor into a cardiologist group based on the specialty. Later, as the time to handle the ECG arrives, the attribute module 207 may group the doctor based on the doctor's work hours. The dynamic grouping of service providers helps increase accuracy of determining a service provider to receive a consultation request.

In addition to receiving and processing the information about a service provider, the attribute module 207 determines attributes associated with a consultation request. In some embodiments, the attribute module 207 receives attributes associated with a consultation request from a customer. For example, a consultation request may include specific pre-conditions listed as attributes. The attributes indicate preferences of the customer. In some embodiments, a type attribute indicates a type of service provider that the customer prefers, for example, a primary physician, a specialist, or a certain type of specialist. In some embodiments, a selection type attribute indicates a selection type, i.e., a pre-selected service provider, a service provider from a predefined group, etc. If the attribute shows a pre-selected service provider, the consultation request may be automatically forwarded to this specific service provider. However, if the attribute shows a service provider from a predefined group, the consultation request may not be automatically forwarded. The attribute module 207 dynamically groups service providers, and therefore a service provider that used to be part of a group may not currently belong to the group.

In some embodiments, a group attribute indicates a customer preference about how to group service providers, for example, based on specialty, practice, provider organization or schedules. In some embodiments, a location attribute indicates a customer preference for a location of a service provider, for example, a given location. In some embodiments, a distance attribute indicates the customer preference for distance of a service provider, for example, selecting a service provider within a distance of a given location. Other types of attributes may indicate customer preferences for work hours, gender, linguistic ability of a service provider, etc. One skilled in the art will recognize that attributes may indicate other customer preferences.

In some embodiments, the attribute module 207 receives attributes that contain inclusive selections and/or exclusive selections. For example, a distance attribute may indicate selecting a service provider within 10 miles from a location and not selecting a service provider outside 30 miles from the location. Or a type attribute indicates that a customer does not want to connect with a specific service provider.

In some embodiments, the attribute module 207 receives indications of importance of attributes from a customer. For example, a patient at node 109 may select a set of attributes from a list of predefined attributes that is displayed on the computing device 115a. The patient may also select a check box or move a slide bar associated with an attribute to indicate an importance of the attribute. In some embodiments, the attribute module 207 receives attributes indicated as mandatory or conditional. The mandatory attributes are “must have” attributes and the conditional attributes are desirable attributes. In other embodiments, the attribute module 207 receives priorities of attributes from a customer.

In other embodiments, the attribute module 207 receives a consultation request generated based on a report associated with a customer by the request module 205, and determines attributes associated with the consultation request. In some embodiments, the attribute module 207 determines attributes based on the information of the report. In some embodiments, the attribute module 207 identifies a type of the report based on the format of the report, and determines a type attribute based on the type of the report. For example, the attribute module 207 determines that a report is an electrocardiogram (ECG) because the report is in a standard electrocardiogram format. The attribute module 207 may determine a type attribute indicating that a cardiologist should be selected based on the report being an ECG. In other embodiments, the attribute module 207 identifies a source, a time, a department, a person, and other information that is related to the creation of the report, and uses the information to determine attributes for the consultation request generated based on the report. For example, the attribute module 207 may identify a source and a time that the ECG was taken. The attribute module 207 uses the source to determine a location attribute for the consultation request such as selecting a specific location for the consultation request when the ECG was originated from a specific source, and uses the time to determine a time attribute for the consultation request such as forwarding the consultation request before noon when the ECG was taken in morning.

In some embodiments, the attribute module 207 also determines attributes based on information about the customer. For example, the attribute module 207 determines an attribute based on medical records of a patient. If three doctors have treated the heart disease patient suffers from and a consultation request was generated based on an ECG recently taken for the patient, the attribute module 207 determines an attribute of the consultation request that indicates a selection of doctors from these three doctors.

When a consultation request is automatically generated based on a report associated with a customer, the attribute module 207 cannot depend on input from the customer to determine importance of attributes. In such case, the attribute module 207 enforces at least one system-defined rule to determine importance of attributes. For example, for a consultation request generated based on a ECG taken for a patient, the attribute module 207 may determine whether a location attribute or a time attribute takes priority based on an initial analysis of the ECG. If no obvious abnormality is shown on the ECG, the location attribute takes priority over the time attribute to follow certain regulation. Otherwise, the time attribute takes priority such that a diagnosis based on the ECG can be obtained as soon as possible. In some embodiments, when a customer has submitted a consultation request but was unable to specify the importance of attributes, the attribute module 207 may also enforces system-defined rules to determine importance of attributes for the consultation request.

In some embodiments, the attribute module 207 also determines other types of attributes for a consultation request. The consultation request is either from a customer or is generated based on a report associated with a customer. For example, the attribute module 207 determines a state of a consultation request such as “open,” “in processing,” “complete” in the context of scheduling implementation. In some embodiments, the attribute module 207 communicates with the notification module 217 to track the processing of a consultation request and update the attributes of the consultation request in run-time.

In some embodiments, the attribute module 207 also pre-filters a list of attributes provided to a customer based on the information about a plurality service providers. For example, a doctor works at a first location on Tuesday and works at a second location on Wednesday. When providing a list of attribute options for selecting by a patient at node 109, the attribute module 207 would remove this specific doctor from a list of doctors that work at the first location on Wednesday. In another example, this attribute list may not include a doctor if the doctor is on vacation, or may place the four doctors that have treated a patient in the past on top of the list shown to this patient. By providing pre-filtered attributes to a customer, the customer is more likely to be accepted by a service provider, and therefore increases the success rate of scheduling.

The scheduler 209 may include software and/or logic to provide the functionality for receiving information about a plurality of service providers, a consultation request of a customer, attributes associated with the consultation request and indications of importance of the attributes, determining which service providers should receive the consultation request, and forwarding the consultation request to at least one service provider.

The scheduler 209 schedules a consultation based on a consultation request of a customer by routing the consultation request to an appropriate service provider. For example, the scheduler 209 schedules a virtual and remote consultation for a patient without a prior appointment when the patient makes a consultation request using the computing device 115a at the node 109. In other embodiments, the scheduler 209 schedules a consultation based on a consultation request that is automatically generated based on a report associated with a customer. For example, the scheduler 209 schedules an offline consultation for timely reporting an x-ray when the request module 205 receives the x-ray associated with a patient and generates a consultation request based on the x-ray. In some other embodiments, the scheduler 209 schedules an appointment between a customer and a service provider. Or the scheduler 209 works as an open-access scheduler to reasonably allocate redefined time to a walk-in customer (e.g., a patient), where the redefined time is from a cancellation of a scheduled time.

In some embodiments, the scheduler 209 includes a rule engine 211, a scheduling module 213, and a notification module 215. The rule engine 211 generates a set of rules for a consultation request of a customer based on attributes associated with the consultation request and indications of importance of the attributes. In some embodiments, the rule engine 211 defines a set of rules for a consultation request received from a customer based on attributes associated with the consultation request. In some embodiments, the rule engine 211 defines a customer and provider specific rule. For example, if the attributes indicate the customer preference for a female and Italian speaking service provider, the rule engine 211 may define a first rule as grouping service providers based on gender and excluding males, and define a second rule as grouping service providers based on linguistic ability and including service providers in an Italian speaking group. Similarly, the rule engine 211 may also define a third rule (e.g., a time-of-day based rule) as including service providers that are available at 9:00-11:00 AM based on another attribute from the customer. In some embodiments, the rule engine 211 defines a source location based rule. For example, the rule engine 211 defines a rule as including service providers in an area based on a location attribute received from a customer. The source location based rule is helpful to address regulatory, multi-tenancy and other business preferences.

In other embodiments, the rule engine 211 defines a set of rules for a consultation request generated based on a report. In some embodiments, the rule engine 211 uses attributes determined from information associated with the report. As described above, the rule engine 211 also defines a source location based rule (e.g., based on a source location of a report) and a time-of-day based rule. The time-of-day based rule is particularly useful because this rule ensures that a report can be responded to in a timely manner. For example, if the report was created at 1:30 PM, the rule engine 211 defines a time-of-day based rule to indicate that the report should be responded to before 4:00 PM of the same day. In some embodiments, the rule engine 211 defines a rule based on a type of report, for example, a consultation request based on an electrocardiogram should go to a generalist or a cardiologist. In other embodiments, the rule engine 211 defines a rule using attributes determined from information about a customer associated with the report. For example, the rule engine 211 defines a rule for selecting a service provider from one or more service providers that have previous interactions with the customer.

In some embodiments, for a consultation request generated based on a report associated with a customer, the rule engine 211 may also define a rule based on an initial analysis of the report. In some embodiments, the initial analysis includes retrieving previous reports associated with a customer from a database within a given time span, and comparing the previous reports and the currently received report. In some embodiments, the rule engine 211 (e.g., an analysis engine included in the rule engine) performs the initial analysis. In other embodiments, the initial analysis is conducted by personnel at node 109 or hub 111. Depending on the comparison result, the rule engine 211 may define different rules. For example, if a comparison between previous x-rays and a current x-ray of a patient shows a significant change, the rule engine 211 defines a rule directing a consultation request generated based on the current x-ray to a specialist. Otherwise, the rule engine 211 defines a rule directing the consultation request to a generalist.

In some embodiments, for a consultation request generated based on a report associated with a customer, the rule engine 211 may determine an urgency level of a report and define a rule based on the urgency of the report. In some embodiments, the rule engine 211 determines the urgency of the report based on an initial analysis of the report. In other embodiments, the rule engine 211 determines urgency of the report based on whether a measurement of the report is beyond a threshold. For example, if an ECG of a patient is read by a device and the reading shows that the heartbeat of the patient includes an irregular pattern, the rule engine 211 determines that the report is urgent. The rule engine 211 defines different rules based on different urgency levels of a report.

Once the rules are defined, the rule engine 211 weights the rules based on importance of the attributes and ranks the rules based on the weights. In some embodiments, the importance of attributes is indicated as mandatory or optional. The rule engine 211 ranks the rule defined based on a mandatory attribute over the rule defined based on an optional attribute. In other embodiments, the importance of attributes are indicated as priorities. The rule engine 211 orders a rule based on the priority of the attribute that is used to define the rule. The rule engine 211 generates a set of rules based on defining the rules and ranking the rules.

The rule engine 211 generates rules dynamically. First, attributes provided by a customer are dynamic. A customer provides the attributes in an encounter, e.g., when arriving the node 109. The rule engine 211 therefore generates rules on-the-fly based on dynamic attributes. Second, weights associated with the attributes are dynamic. Third, the rule engine 211 may define or modify rules in run-time based on the context of scheduling implementation. For example, the rule engine 211 may add a new rule in run-time based on the implementation of initially defined rules. Similarly, the rule engine 211 may modify a rule for selecting a primary physician to a selection of other physicians because a time-of-day rule indicates that the primary physician is not on call at a specific time of day. Finally, the rule engine 211 may dynamically adjust the rules to adapt to other changes. For example, if a report is originated from a first location and a business policy regarding the first location changes, the rule engine 211 may change a source location rule to direct a consultation request generated based on the report to a second location instead of the first location.

Although the rule engine 211 generates rules dynamically, the rule engine 211 may also generate static rules. A static rule is a rule from known attributes, for example, a rule indicating that a consultation request must go to specific service providers, a rule indicating that a consultation can only be conducted at a specific time or a specific day. One skilled in the art will recognize that various types of rules other than example rules described above may be generated by the rule engine 211 for a consultation request.

The scheduling module 213 evaluates information about a plurality of service providers based on a set of rules generated for a consultation request of a customer, and identifies, from the plurality of service providers, a recommended list of service providers. The recommended list includes potential candidates of service providers to which the consultation request can be routed.

In some embodiments, when a plurality of service providers are logged into the system 100, the attribute module 207 receives information about the plurality of service providers. The information about a service provider may include information describing ability of the service provider such as linguistic ability, specialty, licenses, practice, provider organizations, and other information such as a name, a gender, a registration identifier, work locations, work hours, etc. The attribute module 207 transmits the information about the plurality of service providers to the scheduling module 213.

The scheduling module 213 evaluates the information about the plurality of service providers based on a set of rules generated for a consultation request of a customer by the rule engine 211. In some embodiments, the scheduling module 213 applies the set of rules and matches the information about the plurality of service providers to the application of the set of rules. The scheduling module 213 computes a recommendation score for each of the plurality of service providers based on the match result, and identifies whether there is a service provider that satisfies the set of rules based on the recommendation score. For example, the scheduling module 213 determines that a service provider satisfies the set of rules if the recommendation score of the service provider is above a predefined threshold score.

In some embodiments, the rule engine 211 generates rules based on mandatory attributes or conditional attributes. If the scheduling module 213 determines that the information about a service provider does not match a rule associated with a mandatory attribute, the scheduling module 213 assigns a negative recommendation score to the service provider. The negative recommendation score indicates that the service provider does not satisfy the set of rules. If the scheduling module 213 determines that the information about a service provider matches some or all rules associated with mandatory attributes, the scheduling module 213 computes a recommendation score for the service provider to represent a level of match to the application of rules associated with conditional attributes.

In some embodiments, the rule engine 211 generates rules based on attributes associated with the priorities. The scheduling module 213 computes a recommendation score based on the priorities. For example, the scheduling module 213 applies a first rule to obtain a group, and applies a second rule to obtain an area around a location. According to the rules, a consultation request should be routed to service providers of the group that work in the area. The scheduling module 213 determines that a first service provider is part of the group but does not work in the area. The scheduling module 213 determines that a second service provider works in the area but does not belong to the group. If the rule engine 211 ranks the first rule higher than the second rule based on the priorities of corresponding attributes, the scheduling module 213 may compute a recommendation score for the first service provider that is higher than the recommendation score for the second service provider.

In some embodiments, the scheduling module 213 identifies whether there is a service provider that satisfies the set of rules based on the recommendation score. If there is a service provider that satisfies the set of rules, the scheduling module 213 adds the service provider to a recommended list of service providers. If there is no service provider that satisfies the set of rules, the scheduling module 213 provides multiple options. In some embodiments, the scheduling module 213 may provide an alternative service provider and add the alternative service provider to the recommended list. For example, the scheduling module 213 determines the service provider that has a recommendation score below, but closest to, a threshold score or the service provider that has a maximum number of matched rules as the alternative provider. In other embodiments, the scheduling module 213 may communicate with the node 109 or hub 111 to notify the customer that no service provider satisfies the rules, and to instruct a user interface to be displayed on the node 109 or hub 111 such that the customer can resubmit the consultation request with modified attributes. In some other embodiments, the scheduling module 213 may communicate with the node 109 or hub 111 to notify the customer that no service provider satisfies the rules, and to receive a response from the customer regarding whether to wait for the right service provider. If the customer chooses to wait, the entire scheduling may be repeated after a certain time interval. If the customer chooses not to wait, the scheduling module 213 may provide one or more alternative providers to the customer and receive a selection of the alternative provider from the customer. As described above, the alternative providers could be N providers with top N recommendation scores.

The notification module 215 communicates with the node 109 or hub 111 via the communication unit 241 to forward a consultation request to at least one service provider selected from the recommended list of service providers. In some embodiments, when a consultation request is from a customer, the notification module 215 provides the recommended list of service providers to the customer, and receives a selection of a service provider of the recommended list from the customer. Responsive to the selection of the service provider, the notification module 215 forwards the consultation request to the selected service provider, and receives an acceptance of the consultation request from the selected service provider. The notification module 215 notifies the customer of the acceptance of the consultation request by the selected service provider. The notification module 215 also communicates with the attribute module 207 to modify the availability status of the selected service provider to be unavailable. The unavailability status indicates that the selected service provider is unavailable for other consultation requests. If the notification module 215 does not receive an acceptance of the consultation request from the selected service provider within a given time span, in some embodiments, the notification module 215 notifies the service providers of the recommended list of the consultation request, selects the service provider that first responds the consultation request, and uses the first response from the service provider as an acceptance of the consultation request from the selected service provider.

In some embodiments, when a consultation request is generated based on a report associated with a customer, the notification module 215 forwards the consultation request to the service providers of the recommended list, and receives an acceptance of the consultation request from a service provider of the recommended list. In some embodiments, the notification module 215 sends out a notification to remind the service provider that a report is waiting for processing.

The notification may include a link to the report, which presents the report to the service provider when clicked. The notification may also make notes and submit an analysis result using the link. In some embodiments, the notification module 215 also notifies other service providers of the recommended list of the acceptance of the consultation request by the service provider. This notification signals the other service providers of the recommended list that the consultation request has been handled and is no longer available.

Since the notification module 215 filters connections to matched service providers, e.g., a service provider selected by a customer or service providers of the recommended list, the notification module 215 avoids massive connections to all available service providers, which greatly reduces network traffic and increases efficiency.

The notification module 215 also monitors the state of the consultation request and communicates with the attribute module 207 to update the state of the consultation request. For example, when a service provider starts to analyze the consultation request, the notification module 215 communicates with the attribute module 207 to update the state of the consultation request to “in processing.” When the service provider finishes the analysis and reports a consultation result, the notification module 215 communicates with the attribute module 207 to update the state of the consultation request “complete.”

In one implementation, the scheduler 209 may create an active encounter object when receiving a consultation request for a new encounter. The scheduler 209 may return a handle for the object to the caller (e.g., a customer). The handle is used as a reference in all future transactions with the caller and a callee (e.g., a service provider). For example, the scheduler 209 may use this handle to notify a service provider to process the consultation request and notify the customer that the service provider has accepted the consultation request. The scheduler 209 may also monitor the state of each consultation request and update the state of the consultation request until the consultation is complete. Based on tracking each consultation request, the scheduler 209 can notify a customer or a service provider of the change in state of an encounter. In addition, the scheduler 209 ensures atomicity of transactions by supporting conditional state transition operations thereby addressing race conditions. For example, if a plurality of service providers are notified of a consultation request and more than one of the service providers decide to select the patient for consultation the conditional state transition operations only allows one of the service providers accepts the consultation and will be connected.

The user interface engine 217 may include software and/or logic for providing user interfaces to a user. In some embodiments, the user interface engine 217 generates a user interface including a list of predefined attributes and transmits the user interface to the node 109 or hub 111 for display to a user to select a set of attributes and corresponding importance. In other embodiments, the user interface engine 217 receives instructions from the scheduler 209, and sends graphical user interface data to the computing device 115 of the node 109 or hub 111 via the communication unit 241 causing a recommended list of service providers to be displayed in a user interface. In some other embodiments, the user interface engine 217 communicates with the scheduler 209 to generate user interfaces that allow a customer to receive one or more alternative providers and to send a selection of the alternative provider.

FIG. 3 depicts a flow diagram 300 illustrating one embodiment of a method for determining and notifying a service provider of a consultation request based on dynamically generated rules. As described above, the scheduling and reporting application 107 may include a request module 205, an attribute module 207, and a scheduler 209. At 302, the attribute module 207 receives information about a plurality of service providers. At 304, the request module 205 communicates with the attribute module 207 to receive a consultation request associated with attributes. In some embodiments, the request module 205 receives the consultation request and associated attributes from a customer. In other embodiments, the request module 205 receives a report associated with a customer and generates the consultation request based on the report associated with the customer. The attribute module 207 determines attributes of the consultation request based on the information of the report and the information about the customer.

At 306, the scheduler 209 generates a set of rules based on the attributes associated with the consultation request. At 308, the scheduler 209 identifies, from the plurality of service providers, a recommended list of service providers by evaluating the information about the plurality of service providers based on the set of rules. The recommended list includes one or more potential candidate service providers for handling the consultation request. At 310, the scheduler 209 forwards the consultation request to at least one service provider selected from the recommended list. In some embodiments, the service provider is selected by a customer.

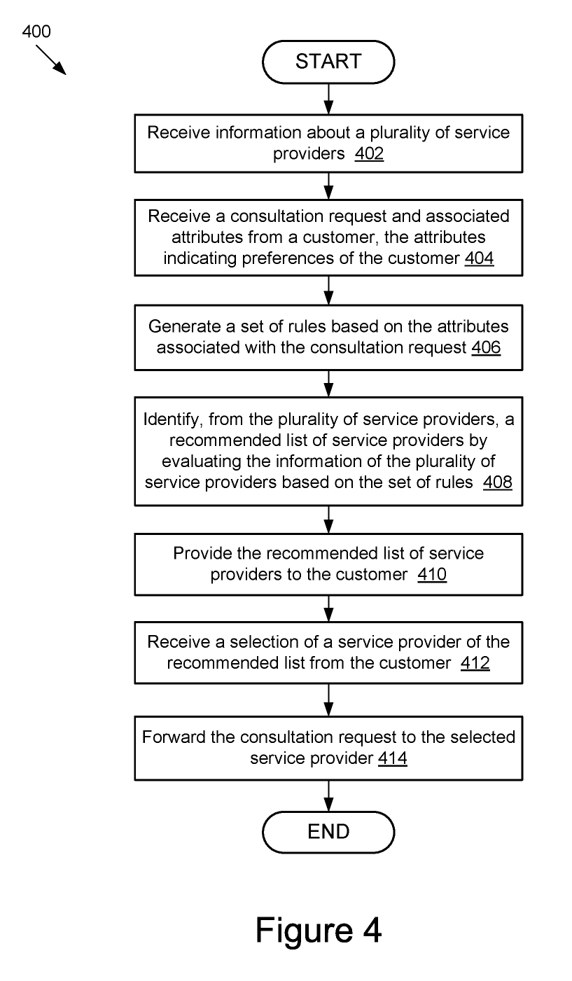

FIG. 4 depicts a flow diagram 400 illustrating one embodiment of a method for receiving a consultation request from a customer, and determining and notifying a service provider of the consultation request using a dynamic rule-based mechanism. As described above, the scheduling and reporting application 107 may include a request module 205, an attribute module 207, a scheduler 209, and a user interface engine 217. At 402, the attribute module 207 receives information about a plurality of service providers. At 404, the request module 205 receives a consultation request and associated attributes from a customer, the attributes indicating preferences of the customer. At 406, the scheduler 209 generates a set of rules based on the attributes associated with the consultation request. At 408, the scheduler 209 identifies, from the plurality of service providers, a recommended list of service providers by evaluating the information about the plurality of service providers based on the set of rules. At 410, the scheduler 209 instructs the user interface engine 217 to provide the recommended list of service providers to the customer, and, at 412, receive a selection of a service provider of the recommended list from the customer. At 414, the scheduler 209 forwards the consultation request to the selected service provider.

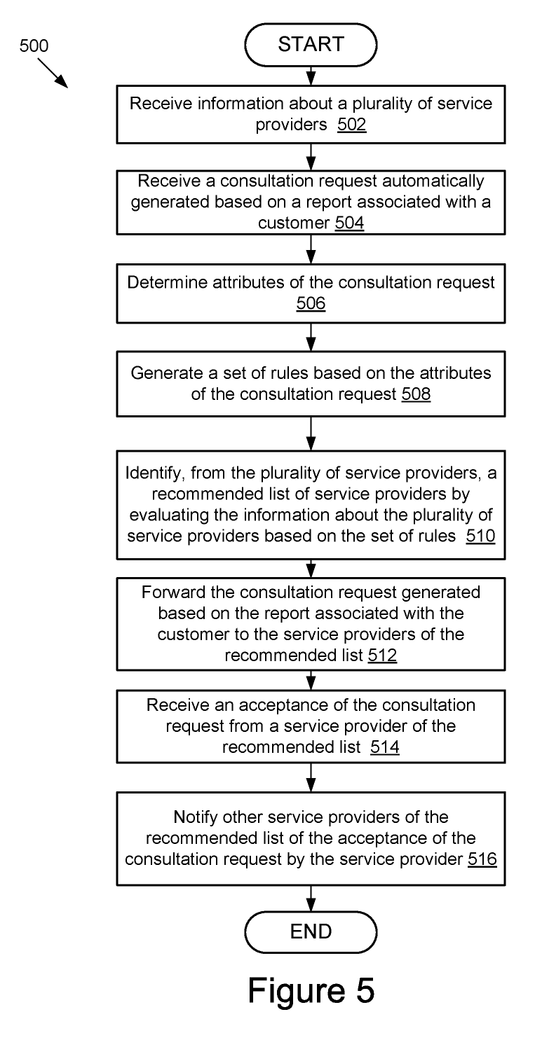

FIG. 5 depicts a flow diagram 500 illustrating one embodiment of a method for generating a consultation request based on a report associated with a customer and determining to which service provider the consultation request should be routed using a dynamic rule-based mechanism. As described above, the scheduling and reporting application 107 may include a request module 205, an attribute module 207, a scheduler 209, and a user interface engine 217. At 502, the attribute module 207 receives information about a plurality of service providers. At 504, the request module 205 receives a consultation request automatically generated based on a report associated with a customer. At 506, the attribute module 207 determines attributes of the consultation request. At 508, the scheduler 209 generates a set of rules based on the attributes of the consultation request. At 510, the scheduler 209 identifies, from the plurality of service providers, a recommended list of service providers by evaluating the information about the plurality of service providers based on the set of rules. At 512, the scheduler 209 forwards the consultation request generated based on the report associated with the customer to the service providers of the recommended list. At 514, the scheduler 209 communicates with the user interface engine 217 to receive an acceptance of the consultation request from a service provider of the recommended list. At 516, the scheduler 209 instructs the user interface engine 217 to notify other service providers of the recommended list of the acceptance of the consultation request by the service provider.

A system and method for determining and notifying a service provider of a consultation request based on dynamically generated rules has been described. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one embodiment above primarily with reference to software and particular hardware. However, the present invention applies to any type of computing system that can receive data and commands, and present information as part of any peripheral devices providing services.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

Some embodiments can take the form of an entirely hardware embodiment, an entirely software embodiment or an embodiment containing both hardware and software elements. One embodiment is implemented in software, which includes but is not limited to firmware, resident software, microcode, etc.

Furthermore, some embodiments can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code can include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the techniques are not described with reference to any particular programming language. It will be appreciated that a variety of programming languages may be used to implement the teachings of the various embodiments as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
receiving, by one or more processors, information about a plurality of service providers;
receiving, by the one or more processors, a consultation request automatically generated based on a report associated with a customer;
determining, by the one or more processors, attributes of the consultation request;
generating, by the one or more processors, a set of rules based on the attributes of the consultation request;
identifying, by the one or more processors, from the plurality of service providers, a recommended list of service providers by evaluating the information about the plurality of service providers based on the set of rules; and
forwarding, by the one or more processors, the consultation request generated based on the report associated with the customer to the service providers of the recommended list.

2. The computer-implemented method of claim 1, wherein identifying the recommended list of service providers by evaluating the information about the plurality of service providers based on the set of rules comprises:
identifying whether there is a service provider that satisfies the set of rules; and
responsive to identifying that no service provider satisfies the set of rules, providing an alternative service provider and adding the alternative service provider to the recommended list.

3. The computer-implemented method of claim 1, further comprising:
receiving an acceptance of the consultation request from a service provider of the recommendation list; and
notifying other service providers of the recommendation list of the acceptance of the consultation request by the service provider.

4. The computer-implemented method of claim 3, further comprising:
receiving a consultation result from the service provider; and
updating the attributes of the consultation request.

5. The computer-implemented method of claim 1, wherein the set of rules includes at least one of source location based rules, time of day based rules, and rules based on report types.

6. The computer-implemented method of claim 1, wherein determining the attributes of the consultation request further comprises identifying a type of the report.

7. The computer-implemented method of claim 1, further comprising:
retrieving previous reports of the customer from a database;
performing an initial analysis based on comparing the previous reports and the report; and
wherein identifying, from the plurality of service providers, the recommended list of service providers is based on the initial analysis.

8. The computer-implemented method of claim 1, further comprising:
determining urgency of the report; and
wherein generating the set of rules and identifying the recommended list of service providers are based on the urgency.

9. A system comprising:
one or more processors; and
a memory, the memory storing instructions, which when executed cause the one or more processors to:
receive information about a plurality of service providers;
receive a consultation request automatically generated based on a report associated with a customer;
determine attributes of the consultation request;
generate a set of rules based on the attributes of the consultation request;
identify, from the plurality of service providers, a recommended list of service providers by evaluating the information about the plurality of service providers based on the set of rules; and
forward the consultation request generated based on the report associated with the customer to the service providers of the recommended list.

10. The system of claim 9, wherein to identify the recommended list of service providers by evaluating the information about the plurality of service providers based on the set of rules, the instructions cause the one or more processors to:
identify whether there is a service provider that satisfies the set of rules; and
responsive to identifying that no service provider satisfies the set of rules, provide an alternative service provider and add the alternative service provider to the recommended list.

11. The system of claim 9, wherein the instructions cause the one or more processors to:
receive an acceptance of the consultation request from a service provider of the recommendation list; and
notify other service providers of the recommendation list of the acceptance of the consultation request by the service provider.

12. The system of claim 11, wherein the instructions cause the one or more processors to:
receive a consultation result from the service provider; and
update the attributes of the consultation request.

13. The system of claim 9, wherein the set of rules includes at least one of source location based rules, time of day based rules, and rules based on report types.

14. The system of claim 9, wherein to determine the attributes of the consultation request, the instructions cause the one or more processors to identify a type of the report.

15. The system of claim 9, wherein the instructions cause the one or more processors to:
retrieve previous reports of the customer from a database;
perform an initial analysis based on comparing the previous reports and the report; and
wherein identifying, from the plurality of service providers, the recommended list of service providers is based on the initial analysis.

16. The system of claim 9, wherein the instructions cause the one or more processors to:
determine urgency of the report; and
wherein generating the set of rules and identifying the recommended list of service providers are based on the urgency.

17. A computer program product comprising a non-transitory computer readable medium storing a computer readable program, wherein the computer readable program when executed causes a computer to:
receive information about a plurality of service providers;
receive a consultation request automatically generated based on a report associated with a customer;
determine attributes of the consultation request;
generate a set of rules based on the attributes of the consultation request;
identify, from the plurality of service providers, a recommended list of service providers by evaluating the information about the plurality of service providers based on the set of rules; and
forward the consultation request generated based on the report associated with the customer to the service providers of the recommended list.

18. The computer program product of claim 17, wherein to identify the recommended list of service providers by evaluating the information about the plurality of service providers based on the set of rules, the computer readable program causes the computer to:
identify whether there is a service provider that satisfies the set of rules; and
responsive to identifying that no service provider satisfies the set of rules, provide an alternative service provider and add the alternative service provider to the recommended list.

19. The computer program product of claim 17, wherein the computer readable program causes the computer to:
receive an acceptance of the consultation request from a service provider of the recommendation list; and
notify other service providers of the recommendation list of the acceptance of the consultation request by the service provider.

20. The computer program product of claim 19, wherein the computer readable program causes the computer to:
receive a consultation result from the service provider; and
update the attributes of the consultation request.
